(19) United States
(12) Patent Application Publication
(10) Pub. No.: US 2010/0121968 A1
(43) Pub. Date: May 13, 2010

(54) SYSTEM AND METHOD FOR AUTOMATING OPERATIONS OF HOUSEHOLD SYSTEMS FROM REMOTE APPLICATIONS

(75) Inventor: Jeff M. Clark, Conroe, TX (US)

Correspondence Address: FULBRIGHT & JAWORSKI, LLP, 1301 MCKINNEY, SUITE 5100, HOUSTON, TX, 77010-3095, US

(73) Assignee: QWEBL, Inc.

(21) Appl. No.: 12/616,621

(22) Filed: Nov. 11, 2009

Related U.S. Application Data
(60) Provisional application No. 61/113,411, filed on Nov. 11, 2008.

(51) Int. Cl. G06F 15/16

(52) U.S. Cl. 709/230

(57) ABSTRACT

A system and method is provided for programming and controlling home automation systems. The system includes a client application adapted to encode instructions to operate household devices for transmission over a communications link. The system also includes a translator module adapted to decode and translate the instructions into control signals for controlling operations of household devices. The translator module is further adapted to listen for and encode operation updates of the household device to the client application.

### RELATED APPLICATION

This Application claims the benefit of U.S. Provisional Application No. 61/113,411 filed on Nov. 11, 2008, the contents of which are hereby incorporated by reference in their entirety.

### TECHNICAL FIELD

The disclosed embodiments pertain to the field of home automation systems, and related methods for controlling lights, thermostats, security systems, and audiovisual components (televisions, speakers, DVD/blu-ray players, etc.) and other electrical and mechanical systems in a user's home.

### BACKGROUND

Home automation systems are typically established by networking a series of hardware devices (e.g., electronics, appliances, etc) with a control device. Networked hardware devices communicate using control wiring, embedded signals in the powerline, radio frequency (“RF”) signals, or a combination. Home automation systems are typically installed during construction of a new home, when control wires can be easily added (before the interior walls are installed) and run from hardware devices to one or more control panels that control the environment. Control wiring is particularly hard to retrofit into an existing house. Home automation systems may also communicate using home automation standards, such as INSTEON, X10, European Installation Bus, PLC BUS, KNX, System Box, LonWorks, C-Bus, Universal powerline bus (UPB), UPnP, ZigBee and Z-Wave. When multiple standards are included, bridges are typically employed to translate information from one standard to another (e.g., from X10 to European Installation Bus). The problem with the prior art is that it is hampered by poor software development tools from component manufacturers which result in significant system installation expense.

FIG. 1 depicts a typical home automation installation using the prior art. Hardware components are depicted by rectangles with sharp corners and software components are represented by rectangles with rounded corners. Control panel 11 is generally a touch-panel or other control hardware, such as a button panel, mounted on the wall of a user's home. Control panel 11 includes a user interface firmware module 12, which is a compiled executable file run by the internal processor of control panel 11. Control panel 11 is typically in communication with home automation device 13 via a wired link. The home automation device 13 is a set-top-box that contains a processor 14 to execute custom module control firmware 15. Significant software programming expertise and man hours are required to program, install, and configure the software and hardware components shown in FIG. 1. For example, in order to set-up or modify firmware 12 and 15, the installer must edit the source code, compile it into an executable file, and load the program file into the storage means (RAM, ROM, or otherwise) in the control panel 11 and home automation device 13.

The device software modules 15a-e are typically pre-written blocks of code specific to a particular piece of remote hardware in the user's home, such as camera 16a, light 16b or 16c, thermostat 16d, or A/V device 16e. Additionally, each software module 15a-e is configured to correspond to a button or set of buttons on the user interface 12. Integrators must program, install, and configure modules 15a-e at startup to enable operations of hardware devices 16a-e, and when devices are added to the system.

Unfortunately, the set-up and modification process for the software and hardware components shown in FIG. 1 is time-consuming and confusing, has a high probability for error, and is difficult to debug or revise. A more efficient, dynamic, programming method is therefore desired.

### BRIEF DESCRIPTION

The disclosed embodiments overcome the above and other shortcomings of the prior art. As described herein, the system is both easy to retrofit into existing homes, and easy to install in new construction. The disclosed embodiments solve a long felt need for remotely communicating with household devices by translating control layer data of such devices into messages that are exchanged with remote clients over a communications link. The translator module interprets control layer data for the devices and converts the data into a message format known by the client. The translator module resides within the home automation system, or on the device itself, and is operable to send and receive messages with the client. The client application functions as a control module for devices in the home and as a gateway for the user to interact with system. The client application recognizes and controls the devices in the system based the messaging protocol communicated over the communications link, rather than low level control layer data of the device, thereby avoiding burdensome programming requirements of typical automation systems.

In one disclosed embodiment, the client application is implemented in software that resides on a handheld device or remote server and manages transmission and reception of control messages exchanged with the translator module. The client application displays user-friendly information on a GUI about the each device's location and features, and provides the user with access and control over each device. The client application also encodes and directs device-specific control commands to be sent from the handheld or server to external devices via the translator module. Optionally, a home automation device, or “control box” in the home, executes the translator module to convert messages received over the communications link into low level control signals for operation of the household devices. The client application receives and parses status messages routed by and sent by a translator module from the home automation device. The system thus provides a unique protocol that includes device technical identity, features, settings, and/or status of operation enable message exchange between the translator module and client application.

### [Final Claims Here]

The foregoing has outlined rather broadly the features and technical advantages of the disclosed embodiments in order that the detailed description that follows may be better understood. Additional features and advantages of the disclosed embodiments will be described hereinafter which in addition to the above form the subject of the claims of the disclosed embodiments. It should be appreciated that the conception and specific embodiments disclosed may be readily utilized as a basis for modifying or designing other structures for carrying out the same purposes of the disclosed embodiments. It should also be realized that such equivalent constructions do not depart from the disclosed embodiments as set forth in the appended claims. The novel features which are believed to be characteristic of the disclosed embodiments, both as to its organization and method of operation, together with further objects and advantages will be better understood from the following description when considered in connection with the accompanying figures. It is to be expressly understood, however, that each of the figures are provided for the purpose of illustration and description only and are not intended to define of the limits of the disclosed embodiments.

### BRIEF DESCRIPTION OF THE DRAWINGS

FIG. 1 shows a currently known home automation system.

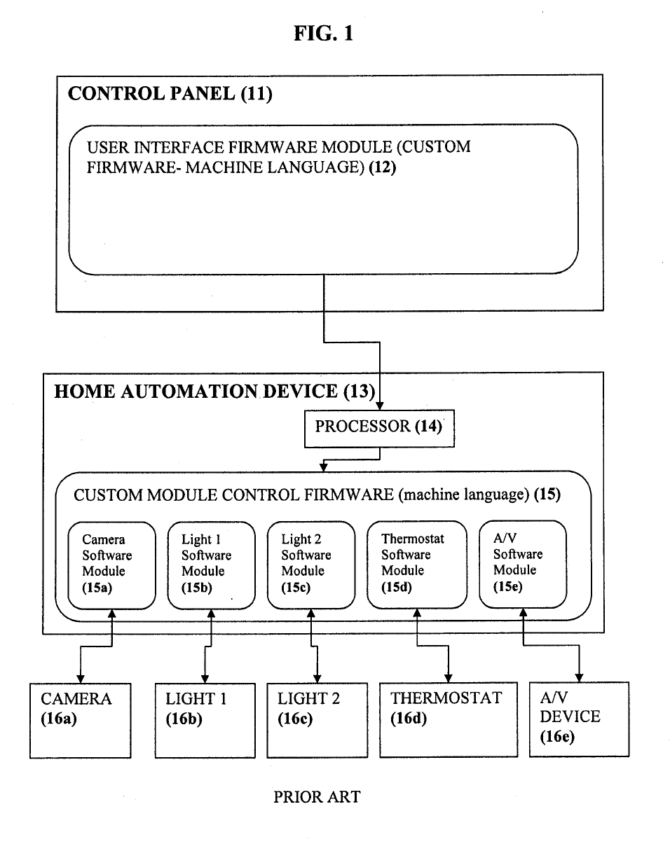

FIG. 2 shows an example embodiment of the client application and translator module.

FIG. 3 shows an example embodiment where automation protocol messages are exchanged between components of the system.

FIG. 4 shows an example embodiment of the client application and translator module connected over a communications link.

FIG. 5 shows an example embodiment in which users remotely log on to the system using a secure connection.

### DETAILED DESCRIPTION

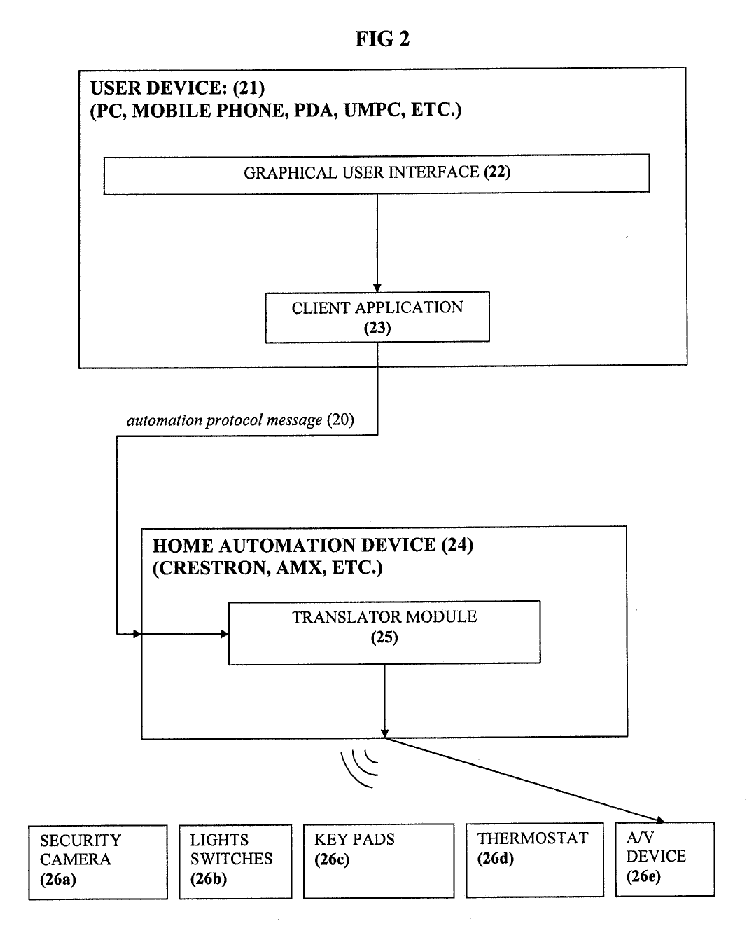

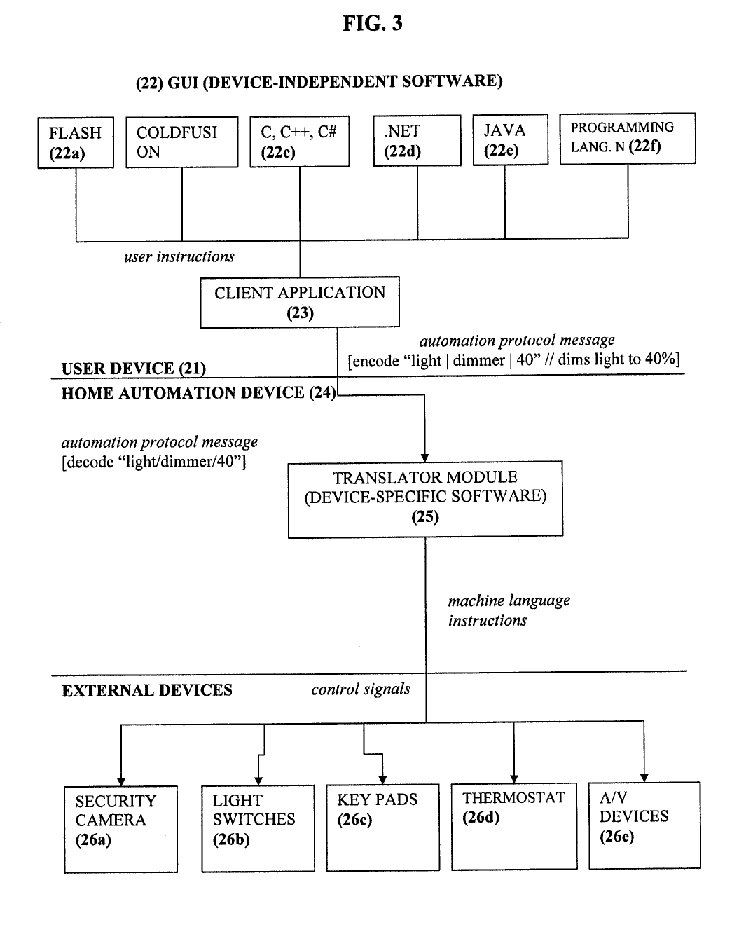

FIG. 2 depicts a generalized block diagram of a disclosed embodiment. The user device 21 may be a personal computer, a mobile phone, smart phone, personal data assistant, Ultra-Mobile Personal Computer, internet tablet, media center personal computer (such as Windows Vista Media Center, by Microsoft Corporation), remote control, digital music player, or any other computing device with wired or wireless communication capabilities. The user device 21 includes a graphical user interface (“GUI”) 22 and client application 23. The client application 23 is preferably a software application programmed in Macromedia Flash, but (as shown in FIG. 3) may be programmed in any suitable programming language, such as Microsoft's .NET framework, Macromedia Coldfusion, C, C++, C#, Sun Microsystems Java and Javascript, HDL, VHDL, etc. The GUI is a hardware interface for the user device 21, such as a touch screen, mouse, keyboard, or any other input device capable of displaying and accessing features of the client application. The GUI is operable to receive a user's instructions to control operations of devices 26a-e in the home, and pass the instructions to the client application 23 for processing and transmission.

The client application 23 is preferably software that executes a series of steps to encode the user's instructions (to control devices 26a-e) into an automation protocol message 20 for transmission over the communications link. In alternative embodiments, the client application is implemented in whole or in part using circuitry or other suitable hardware. The client application preferably resides or downloaded to a handheld user device (see FIG. 2). Alternatively, the client application resides on a server or processor operable to service up automation protocol messages sent remotely from the translator module (not shown). The client application is implemented in a device independent manner so that it can be executed on any of the above listed (or other) user devices.

Steps executed by the client application include receiving a user's instructions to operate a device; converting the user's instructions into an automation protocol message 20, according to a syntax or format that is known to the translator module 25; and encoding the automation protocol messages 20 for transmission over communications link. The client application is detached from the control software residing on the home automation device to avoid device-specific programming of the home automation device. The automation protocol message includes the identity of the device the user wants to control. Upon receipt, the translator module decodes the automation protocol message and translates it to control layer data.

The translator module preferably resides on a home automation device 24, or set-top-box, typically used to controls the operations of various household devices 26a-e. The home automation device may be proprietary or a commercially available model such as those manufactured by Crestron Electronics, Inc. and AMX®, but any suitable alternative device may be used instead. Alternatively, the translator module may also reside on a switch, router, server, database, or other processer remote from the user device and household devices. The translator module 25 is implemented either as a software module or a discrete hardware block. The translator module 25 reads/parses the automation protocol message 20 received from the client application 23 over the communication link and, based on the technical identity of the device specified in the message, translates the message 20 into control level signals for devices 26a-e. For example, the translator may convert the automation protocol message received over the communications into a device-specific control signals such as those used by INSTEON, X10, European Installation Bus, PLC BUS, KNX, System Box, LonWorks, C-Bus, Universal powerline bus (UPB), UPnP, ZigBee, Z-Wave or other similarly enabled devices. The translator module 25 then forwards the control signals to the appropriate hardware device(s) 26a-e.

The translator module 25 tracks and reports information such as status, duration of use, energy consumption, cost, errors, etc. to the client application. The module 25 listens for control level signals from the devices 26a-e and converts the input into automation protocol messages it can send to the client application over the communications link.

Devices 26a-e are preferably connected to the translator module 25 via a wireless radio frequency link in the home automation device 24 (see in devices 26a-d in FIG. 2), or direct wiring (see A/V device 26e in FIG. 2). In response to the automation protocol message, the translator module 25 prepares and forwards control level signals to security cameras 26a, light switches 26b, key pads 26c, thermostat 26d, A/V devices 26e such as receivers, speakers, and televisions, and any other system or device in the user's home.

FIG. 3 depicts interactions between the GUI 22, client application 23, and the translator module 25. The GUI 22 receives a user's inputs, and passes the instructions to the client application 23. The client application 23 then processes and formats the instructions in the automation protocol message. For system programming, the technical identity of the external household device is provided to the client application 23 so the user can pair it with descriptive information on the user interface. To do so, the user first visually identifies a household device and creates descriptive information for it on the user interface 22. The user then matches the description to the device's technical information so that the client application 23 may encode the device's technical identity in future automation protocol messages. Because the automation protocol message specifies the technical identity of the external device, the message is forwarded to the device from the home automation device regardless of it's location in the home, and programming of the set top box is avoided.

One example of the automation protocol message syntax is provided in FIG. 3 (as pseudo code) which can be written in suitable programming languages. For example, in Flash, the client application may invoke an ActionScript function: “onClick(light[n] |“dim”| 40);” in response to a user's selection on the GUI to dim a light “n” to 40%. The ActionScript is preferably encapsulated in a format that may be sent over a communications link, such as Internet Protocol. The translator module 25 receives over the link and parses the message by executing the routines “onClick” and “light”, for the light device identified as “n”, and executing the “dimmer” routine for a value of 40. The translator module 25 then produces a lower level control signal, such as in machine language, and based on the device's specific control layer broadcasts a signal to light switch n (the corresponding switch at 26b) to dim the light to 40% power. Additional features and services of the device are invoked by the automation protocol message as desired. Translator module 25 thus translates the messages received over the communications link into lower level instructions to interface with device 26a-e.

One benefit of the automation protocol messaging is that instead of forcing the installer to painstakingly program each device's functionality/identity for the home automation device, a single application can be written in a high level language for the user device and home automation device, in a manner that permits portability to multiple hardware platforms. Another advantage is that the automation protocol message provides routing information sufficient for any home automation device to properly route the control message to the external device without custom programming. External-device to home-automation-device programming need not be performed, as routing information is already encoded in the home automation protocol message.

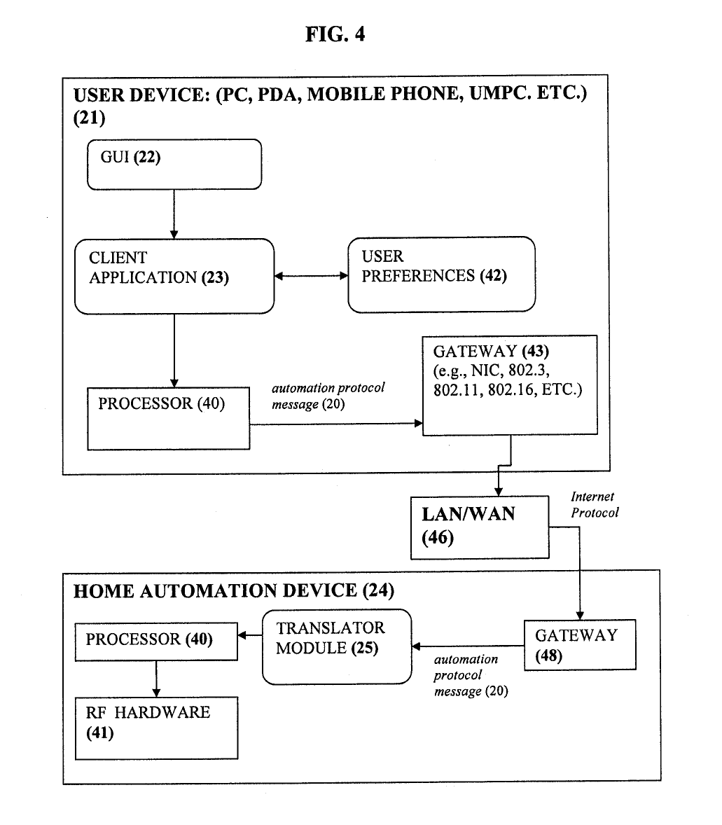

FIG. 4 depicts one embodiment of the disclosed embodiments through which automation protocol messages 20 are generated and transmitted to devices in the home. Client application 23 reads stored user preferences 42 (which represent meaningful identifying information for each device such as the device's name and location in the home, for example) from a memory means within user device 21 (or alternatively, stores this information on a remote server, see FIGS. 6 and 7). The client application 23 displays this information to the user over the GUI 22 for the user to control and review status of each device. In response to a user's selections, the client application 23 encodes the automation protocol message 20. The automation protocol message is sent to the user device 21′s gateway 43, preferably a network identification card (“NIC”) 43, which encapsulates the data into Internet Protocol packets for transmission onto a communications link (e.g., Ethernet/802.3, 802.11. WIFI, WIMAX, etc). The instructions are then transmitted over a local network or wide area network 46 to gateway 48 of the home automation device 24. Once the instructions are received, the device's (24) processor translates the automation protocol messages 20 using the translator module 25, parsing the message in search of the device's technical identity and control commands. Based on such information, RF hardware 41 in the home automation device routes the user's instructions to the corresponding external device in the home (see FIG. 2).

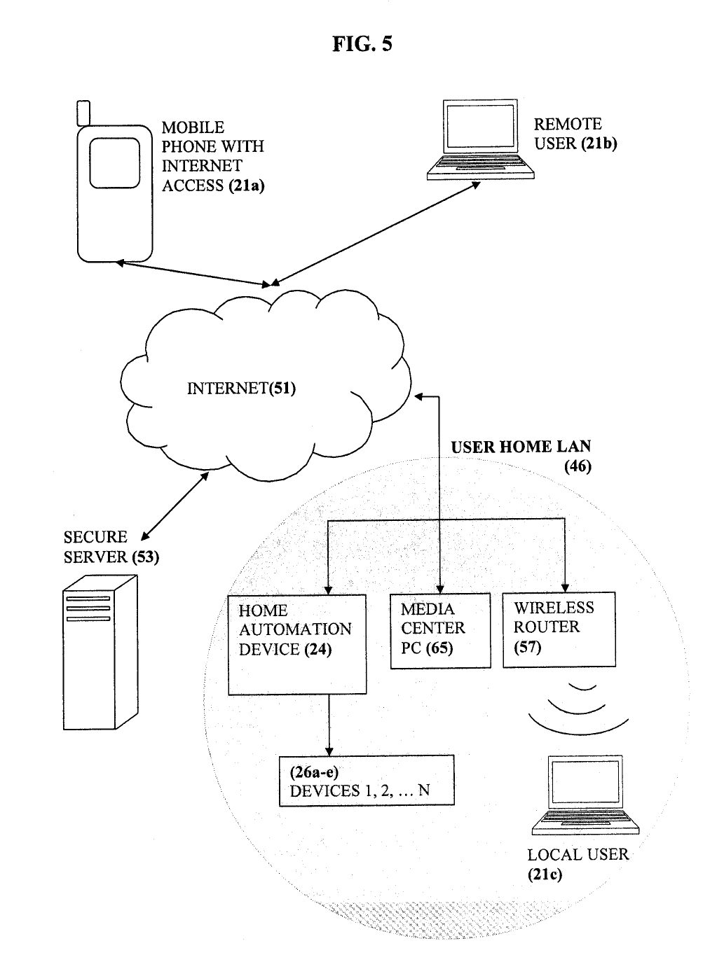

FIG. 5 depicts an embodiment wherein the user connects to the home automation device via a secure server over the Internet 51. A user may be away from his or her home local area network 46, yet still desire to control a device 26a-e within the home. This may be achieved remotely by using an Internet enabled computing device, such as mobile phone 21a or laptop computer 21b. The user connects through the Internet 51 to a website hosted on a secure server 53. The server houses user preferences and settings (element 42 of FIG. 4) along with the client application 23. After authentication, the user is able to connect to this website and run the application off the web server through a browser as if running the application locally at the server. The secure server 53 then establishes a secure tunnel through Internet 51 to allow the server to communicate with the user home network 46, and issues automation protocol messages 20 directly to the home automation device 24 over the Internet 51. In this arrangement, the user may continue to control the hardware devices 26a-e from a remote location using the disclosed system and method.

FIG. 5 also depicts an embodiment wherein the PC user 21c may connect directly to the user's home wireless LAN 46 directly through wireless router point 57 to control the home automation device 24. An application housed in user machine 21c actively searches for the local area network to which the home automation device 24 is connected, and, upon finding the network, automatically connects user device 21c to the network. Alternatively, if the user is “roaming” (as depicted by user device 21b), the application cannot detect the user's home wireless LAN 46, and the user may connect to the secure server 53 through the Internet 51. Once connected, the user (21b, 21c) can interact with the home automation system using the disclosed system and method.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims. For example, the above described automation system may used in an office setting, as well as in the user's home; one or multiple user devices, one or multiple home automation devices, and user devices may be included in the home automation system; the home automation network may be implemented with a traditional or distributed network architecture; and the client application and translator module may swapped or combined on devices, and can be executed in any relative order to carry out objectives of the disclosed embodiments.

What is claimed is:

1. A method of using a translator module to facilitate communications between a household device and remote user device, the method comprising the steps of:
the translator module receiving an automation protocol message representing user instructions over a communications link from the remote user device to control the household device,
wherein the remote user device is remote from the translator module and the household device,
wherein the remote device and the translator module communicate using an automation protocol, and
wherein the household device communicates using a protocol different from the automation protocol;
the translator module translating the automation protocol message into a control signal for controlling the household device according to the user instructions;
the translator module sending the control signal to control the household device;
the translator module receiving a reply signal from the household device representing operations of the household device;
the translator module formatting the reply signal into an automation protocol message for transmission over the communications link to the remote user device; and
the translator module sending to remote user device the automation protocol message to report operations of the household device.

2. The method of claim 1, wherein the translator modules sends the reply signal over a communication link using the Internet Protocol.

3. The method of claim 2, wherein the step of translating further includes the translator module encoding the control signal in a lower level language than the automation protocol message.

4. The method of claim 3, wherein the step of translating further includes the translator module:
determining the identity of at least one household device from the automation protocol message; and
matching the identity of the household device to one of a plurality of languages adapted to create the control signal for controlling household device, wherein the plurality of languages are pre-programmed into the translator module.

5. The method of claim 1 wherein the translator module is executed by a processor coupled to a set top box.

6. The method of claim 1 wherein the translator module is coupled to the on/off switch of a household device.

7. The method of claim 1 wherein the translator module is integral with the household device.

8. A method for using a translator device to facilitate communications between a household device and a remote device, the method comprising the steps of:
the translator device receiving instructions over a communications link from the remote device to control the household device, wherein the remote device is remote from the translator device and household device;
the translator device sending the control signal to control the household device according to the instructions received over the communications link;
the translator device receiving status signals representing operations of the household device broadcasted by the household device; and
the translator device translating the instructions into one or more status messages for transmission over the communications link to the remote device, wherein the status messages represent operations of the household device.

9. The method of claim 8, wherein the translator device is coupled with the household device over a wireless link.

10. The method of claim 8, wherein the translator device is mechanically attached to the household device.

11. The method of claim 10, wherein the instructions received over the communications link from the remote device are formatted according to the Internet Protocol.

12. A home automation system comprising:
a client application adapted to encode a user's instructions over a communications link to control operations of a household device, wherein the client application is remote from the household device;
a translator module adapted to translate the user instructions into control signals to control operations of the household device according to the user's instructions; and
wherein the translator module is further adapted:
to receive status signals reporting operations of the household device from the household device;
translate the status signals into reporting messages to report operations of the household device; and
encoding the status messages for transmission over the communications link to the client application.

13. The system of claim 12, wherein the client application is a computer executable program on a handheld device.

14. The system of claim 12, wherein the client application is executed by a web server.

15. The system of claim 13, wherein the client application encodes the user instructions according to the Internet Protocol.

16. The system of claim 12, wherein the translator module is executed by a processor wirelessly connected to the household device.

17. The system of claim 12, wherein the translator module is executed by a processor mechanically coupled to the household device.

18. The system of claim 12, wherein the translator module is integrated with the power control switch of the household device.
